(19) United States
(12) Patent Application Publication
(10) Pub. No.: US 2018/0111438 A1
(43) Pub. Date: Apr. 26, 2018

(54) METHOD AND SYSTEM FOR MEASURING HEIGHT IN A VEHICLE

(71) Applicant: WABCO GmbH, Hannover (DE)

(72) Inventors: Thomas BREHMER, Wiehl (DE); Stefan GROETZINGER, Gehrden (DE); Siegfried HÖFLER, Hannover (DE); Johann LUCAS, Sehnde (DE); Joachim UHL, Nürnbrecht (DE)

(21) Appl. No.: 15/553,371

(22) PCT Filed: Feb. 6, 2016
(86) PCT No.: PCT/EP2016/000207

§ 371 Date: Aug. 24, 2017

(30) Foreign Application Priority Data
Feb. 24, 2015 (DE) 10 2015 002 167.2

(51) Int. Cl. B60G 17/019; B60G 17/015; G01B 7/14; G01B 7/315

(52) U.S. Cl. CPC B60G 17/019; B60G 17/0155; B60G 2401/17; G01B 7/315; B60G 2400/252; G01B 7/14

(57) ABSTRACT

Disclosed is a method for measuring height in a vehicle by determining a distance between a vehicle chassis and a vehicle axle or parts connected thereto. In the method, a first device (12) with a first transmitter (13) and a first receiver (14) and a second device (15) with a second transmitter (16) and a second receiver (17) interact. In particular, the first transmitter (13) produces an electromagnetic field, and the second receiver (17) detects the electromagnetic field. The second device (15) with the second transmitter (16) produces a signal from the detected field and transmits the signal, which correlates with the distance from the first transmitter (13) to the second receiver (17). The first device (12) with the first receiver (14) receives the signal. A system, an electronically controlled pneumatic suspension, an electronic control unit, and a vehicle are also disclosed.

### CROSS-REFERENCE TO RELATED APPLICATIONS

This application is the National Stage of International Application No. PCT/EP2016/000207, filed on 6 Feb. 2016, which claims priority to and all advantages of German Patent Application No. 10 2015 002 167.2, filed on 24 Feb. 2015, the content of which is hereby incorporated by reference.

### FIELD OF THE INVENTION

The invention generally relates to a method for measuring height, and, more specifically, to a method for measuring height in a vehicle by determining a distance between a vehicle chassis and a vehicle axle or parts connected thereto. The invention also relates to a system for measuring height, an electronically controlled pneumatic suspension with the system, a vehicle with the system and an electronic control unit.

### BACKGROUND OF THE INVENTION

Commercial vehicles with a pneumatic suspension are usually fitted with an automatic level control system. As a result, a loaded vehicle has the same height as an unladen vehicle, i.e. the distance between a vehicle chassis and a vehicle axle is not less for a loaded vehicle than for an unladen vehicle.

Part of the automatic level control system is often a mechanical coupling between the vehicle chassis and a vehicle axle, namely a coupling rod, which is usually connected to a displacement sensor for detecting the difference in height. By moving the coupling rod and actuating the displacement sensor, pneumatic valves for ventilating or evacuating the pneumatic suspension are actuated by means of the associated vehicle electronics. If the vehicle is loaded, the vehicle chassis presses on the vehicle axle, the distance reduces and the displacement of the coupling rod causes the opening of a ventilation valve, so that the vehicle chassis is raised back to the original height. The level control is carried out in the opposite direction during unloading of the vehicle. The determination of the height is mechanically complex owing to the combination of the coupling rod displacement sensor and the connection to the electronically controlled pneumatic suspension.

The change of the distance between the vehicle chassis and the vehicle axle is relevant to the level control. This distance can be measured directly or by using auxiliary points, i.e. using parts connected to the vehicle chassis and to the vehicle axle, for example a chassis frame as part of the vehicle chassis on the one hand and parts of the wheel suspension that belongs to the vehicle axle on the other hand.

Various embodiments of a level control system with or without a pneumatic suspension valve are disclosed in WO 2005/049346 A1.

A suspension system for a truck with gas springs and level control is known from DE 197 01 530 C1. A distance measurement takes place within the pneumatic spring by transmitting an ultrasonic signal, transmitting an electromagnetic signal back and measuring the time from the transmission of the ultrasonic signal until the arrival of the electromagnetic signal.

A distance display system for pneumatic springs is known from EP 1 834 190 B1, with a transmission-reception device on one side and a transponder with an antenna on another side. With the antenna, a backscatter modulation is radiated, wherein the modulation changes the amplitude depending on the distance.

A chassis with pneumatic suspension and a level measurement device is disclosed in EP 1 857 305 A1 with an active sensor unit and a passive element. The active sensor unit supplies the passive element with energy by means of an alternating magnetic field, the passive element responds to a request from the active sensor unit and the active sensor unit analyzes the field strength of the response of the passive element.

### SUMMARY OF THE INVENTION

The present invention provides a safe alternative to conventional methods. In particular, in the method a first transmitter of a first device produces an electromagnetic field, and a second receiver of a second device detects the electromagnetic field. The second device produces a signal from the detected field with a second transmitter and transmits the signal, which correlates with the distance from the first transmitter to the second receiver, and the first device receives the signal with a first receiver. The first device then has a signal that represents the distance from the first transmitter to the second receiver. The signal can be fed via customary interfaces to a control unit for an electronically controlled pneumatic suspension.

In certain embodiments, the first device is assigned to the vehicle chassis and the second device is assigned to the vehicle axle (or to respective parts connected thereto). A reverse arrangement with the first device on a part that is assigned to the vehicle axle is also possible. However, the first device with the first transmitter and first receiver is typically mounted on the vehicle chassis or on a part thereof.

According to specific embodiments of the invention, the electromagnetic field produced by the first transmitter is a field with a low frequency, generally less than 135 kHz. In certain embodiments, the electromagnetic field has a frequency of 125 kHz.

According to these or other embodiments, the signal transmitted by the second transmitter is an electromagnetic signal in the high frequency range or in the ultrahigh frequency range, for example of about 433 MHz or 868 MHz.

The use of different frequencies for the signal of the first transmitter and the signal of the second transmitter reduces mutual interference. The low frequency electromagnetic field is typically directed directly towards the second receiver by the design and arrangement of an antenna of the first transmitter. The electromagnetic signal in the high frequency range or in the ultrahigh frequency range is typically encoded and can only be read by the first receiver. Malfunctions caused by closely adjacent vehicles are excluded as a result.

In various embodiments, the second receiver detects the strength of the electromagnetic field. The latter is produced and transmitted by the first transmitter.

In certain embodiments, the first device produces and provides a standardized output signal from the received signal, typically a PWM signal or an analog voltage signal. The output signal can be processed by control units for the pneumatic suspension for the purpose of the level control system or for other purposes connected to a height measurement.

Advantageously, error compensation of the signal may be carried out, preferably before generation of the output signal.

In specific embodiments, the second device with the second transmitter only transmits a signal if a change of the electromagnetic field has been detected by the second receiver. This may depend on the strength or the time profile of the change. In particular, the following process is provided:

The second device stores a value that is correlated with the detected electromagnetic field. After a time interval has elapsed, for example after 20 ms, a new value is detected and compared with the previously stored (old) value. Only if the difference of the values calculated in this way exceeds a predetermined difference are the new value stored and the old value cleared. The second device also produces the signal from the new value and transmits the signal. If the difference of the values is too small, the old value remains stored and a signal is not produced or transmitted. Owing to this process, the supply of energy to the second device is less heavily loaded.

In certain embodiments, the signal transmitted by the second transmitter contains a sender ID. The ID enables there to be a distinction between different transmitters, so that errors caused by mutually adjacent vehicles can be avoided. The first device processes only signals with the “correct” sender ID, i.e. from the associated second device.

In these or other embodiments, the second device only transmits following an identity check and/or after a synchronization process with the associated first device (Listen-Before-Talk principle). This further reduces the risk of mutual interference between multiple devices.

The present invention also provides a system for carrying out the method. In particular, the first transmitter is provided for producing an electromagnetic field and the second receiver is provided for detection of the electromagnetic field. The second device with the second transmitter is provided for producing and transmitting a signal, wherein the signal is correlated with the distance from the first transmitter to the second receiver. The first device with the first receiver is provided for the reception of the transmitted signal, generally also for forwarding and/or further processing of the signal.

In certain embodiments, the first device is associated with the vehicle chassis and is preferably connected to an electrical network of the vehicle—an on-board network. Accordingly, the second device is typically associated with the vehicle axle and in particular is not connected to the on-board network. However, the association can also be reversed.

In these or other embodiments, the second device comprises a dedicated electrical power supply that is preferably independent of an electrical power supply of the first device and of a power supply of the vehicle. In particular, the dedicated electrical power supply is a long-life battery.

In certain embodiments, an electrical power supply for one of, optionally only one of, the two devices is a lithium-ion battery, in particular a lithium-thionyl chloride battery. The lithium-ion battery is preferably provided as the electrical power supply for the second device.

In specific embodiments, an electrical power supply for one of, optionally only one of, the two devices has a capacity of 10 Ah or less, in particular of about 2.5 Ah. The output voltage of the power supply is typically about 5.4 V or less, in particular about 3.6 V.

In certain embodiments, the two devices are attached to the vehicle outside of the pneumatic suspension bellows. The mounting and replacement of the devices are particularly simple as a result.

The method and system can be provided to detect a vehicle axle as a whole. In this case, a simple embodiment with a first device and a second device is sufficient. Alternatively, both ends of a vehicle axle or the wheels of the vehicle axle can be detected. In this case, a respective first device and a respective second device are each associated with each end of the vehicle axle. Finally, a plurality of vehicle axles can also be detected as a whole or at both ends. In this case, a corresponding number of first and second devices are provided.

An electronically controlled pneumatic suspension is also provided, which comprises the system according to the invention. Pneumatic suspension bellows are typically provided as pneumatic springs.

In certain embodiments, the pneumatic suspension is provided with a manually actuated valve arrangement for raising and/or lowering a vehicle body/vehicle chassis. A manually actuated valve arrangement with raising and lowering valves is shown in WO 2005/049346 A1, for example.

In these or other embodiments, the pneumatic suspension comprises a pneumatic suspension valve. A pneumatic suspension with pneumatic suspension valve is shown in WO 2005/049346 A1, for example.

In these or other embodiments, the pneumatic suspension is provided with a pressure sensor for measuring the pressure prevailing within a pneumatic suspension bellows. It is sufficient for this if the pressure sensor is connected on the pressure side to the pneumatic suspension bellows of the pneumatic suspension, such as represented for example in the aforementioned WO 2005/049346 A1.

A vehicle is also provided which comprises a system according to the invention, for example in specific embodiments an air suspension according to the invention.

An electronic control unit is also provided. The control unit can be provided for an electronically controlled pneumatic suspension. An interface is provided for the reception of the signal that is forwarded or further processed by the first device and with software for processing the signal. The signal received by the interface is preferably referred to as the output signal of the first device.

### BRIEF DESCRIPTION OF THE DRAWING

The invention is described in greater detail below with reference to the accompanying figures, in which:

FIG. 1 shows two devices for transmitting and receiving signals in a schematic representation, and

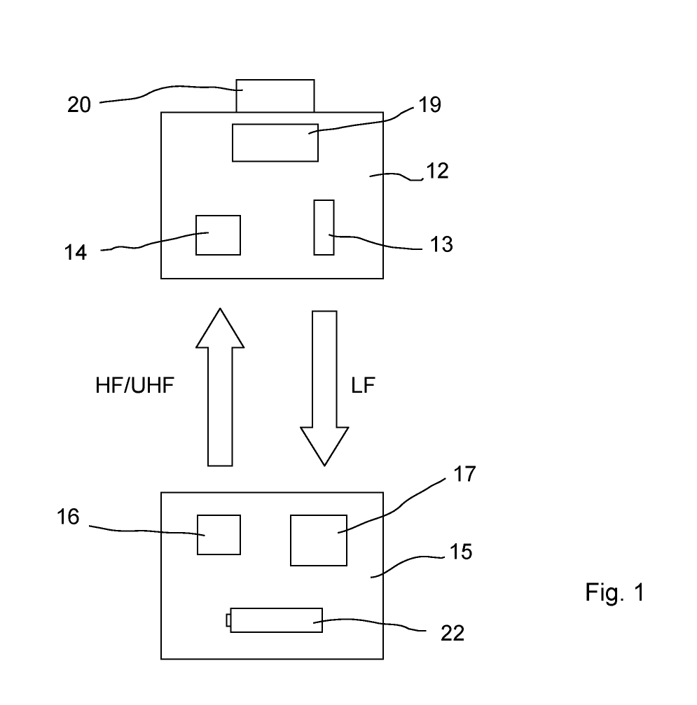

FIG. 2 shows a truck (motor vehicle) with the two devices according to FIG. 1.

### DETAILED DESCRIPTION

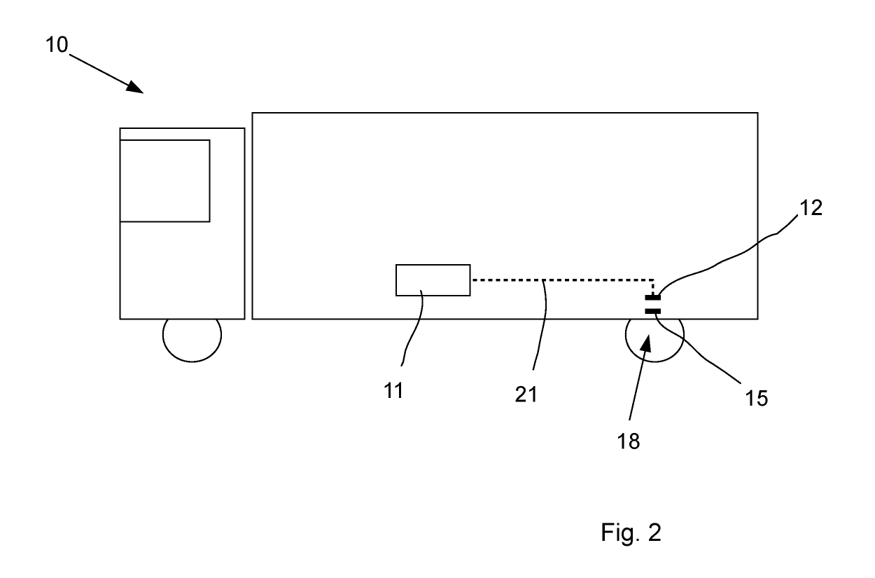

With reference to the specific embodiment of the Figures, wherein like numerals generally indicate like parts throughout the several views, FIG. 2 shows a truck 10 that is equipped in a known manner with a pneumatic suspension that is not shown in detail and an associated control unit 11.

At least one system for measuring height in the truck 10 is installed in connection with the pneumatic suspension. The components of the system are a first device 12 with a first transmitter 13 and a first receiver 14 and a second device 15 with a second transmitter 16 and a second receiver 17. The devices 12, 15 are provided and equipped for transmitting and receiving and for signal processing.

The two devices 12, 15 are oriented towards each other and disposed adjacent to each other but spaced apart from each other, so that the transmission of electromagnetic signals is possible. In this case, the first device 12 is associated with a vehicle chassis, in particular mounted on a chassis frame. The second device 15 is typically associated with a vehicle axle and in particular mounted on an axle support. The arrangement is selected so that the first device 12 is mounted approximately vertically above the second device 15.

Using the two devices 12, 15, a height measurement or a measurement of the change of the distance between the vehicle chassis and the vehicle axle is carried out. The two devices 12, 15 are mounted in the region of a rear axle 18. Alternatively, the system is provided with the two devices 12, 15 twice, namely once on the left and once on the right on the rear axle 18. Yet further measurement points (systems) are possible, for example on a front axle.

The height measurement is carried out cyclically at short intervals, for example at intervals of 25 ms or less.

The first transmitter 13 contains an antenna and produces a low frequency alternating magnetic field of 125 kHz. In certain embodiments, the antenna is oriented towards the second device 15. The magnetic alternating field is oriented accordingly.

The second receiver 17 contains a receiving antenna with an electronic circuit for determining the field strength of the low frequency magnetic field. The associated capability of the circuit is referred to as an RSSI (Received Signal Strength Indication). RSSI is used inter alia in wireless networks according to the IEEE 802.11 Standard.

For the processing of the field strength determined by the second receiver 17, the second device 15 can comprise an electrical circuit that is known in connection with keyless vehicle access systems (keyless entry/go), for example NCF 2952 or NCF 2951 of the manufacturer NXP Semiconductors N. V.

The field strength determined cyclically by the second receiver 17, for example every 20 ms, correlates with the distance between the two devices 12, 15. Accordingly, changes of the distance can be determined from the change of the field strength. The magnitude of the field strength determined by the second receiver 17 is converted in the second device 15 into a high frequency (or ultra-high frequency) signal of preferably 433 or 868 MHz. Moreover, the signal is encoded and/or provided with a sender ID and transmitted by the second transmitter 16.

The first receiver 14 receives and checks (and encodes) the transmitted signal. In the first device 12, the received signal is converted into a standardized output signal. An interface 19 is provided in the first device 12 for this purpose.

Moreover, the first device 12 comprises an in particular multipole socket 20 for connecting a connecting line 21. The latter is connected for forwarding the output signal to the control unit 11 and thus connects the system for measuring height to the control unit 11.

The second device 15 is supplied with electrical energy by an installed long-life battery 22. In contrast, the first device 12 is connected via the line 21 to an on-board network, which is not shown, of the truck 10. The line 21 comprises at least three conductors, namely for ground, unit voltage and signal.

In the case of the arrangement of two systems on the rear axle, both are connected via lines to the control unit 11. The control unit can thus also detect and control a change in height on one side.

A whole series of advantages are linked to the described system. There are no mechanical parts present that can wear. No inaccuracies occur, such as can be caused by bearing play and/or the lateral deflection of a coupling rod. Additional connections are not necessary, preferably only the connection to a control unit. The material costs are low. A direct height measurement is carried out, i.e. the distance measurement is not dependent on a rotary motion, such as with a pivotable coupling rod. As a result, no sinusoidal distortion of the measurement values takes place. The provided devices can be installed directly on the vehicle chassis and on the vehicle axle at almost any locations. Installation in the pneumatic springs is not necessary. In the event of a fault, replacement can be carried out rapidly and inexpensively.

1. A method for measuring height in a vehicle by determining a distance between a vehicle chassis and a vehicle axle or parts connected thereto, with a first device with a first transmitter and a first receiver and a second device with a second transmitter and a second receiver, said method comprising:
producing by the first transmitter an electromagnetic field;
detecting by the second receiver the electromagnetic field;
producing by the second device with the second transmitter a signal from the electromagnetic field;
transmitting by the second device with the second transmitter the signal, which correlates with the distance from the first transmitter to the second receiver;
and receiving the signal by the first device with the first receiver.

2. The method as claimed in claim 1, wherein the electromagnetic field produced by the first transmitter is a field with a low frequency.

3. The method as claimed in claim 1, wherein the signal transmitted by the second transmitter is an electromagnetic signal in the high frequency range or in the ultrahigh frequency range.

4. The method as claimed in claim 1, wherein the second receiver detects the strength of the electromagnetic field.

5. The method as claimed in claim 1, wherein the first device produces a standardized output signal from the received signal and provides the standardized output signal.

6. The method as claimed in claim 1, wherein the second device with the second transmitter only transmits a signal if a change of the electromagnetic field has been detected by the second receiver.

7. The method as claimed in claim 1, wherein the signal transmitted by the second transmitter contains a sender ID.

8. A system for measuring height in a vehicle by determining the distance between the vehicle chassis and a vehicle axle or parts connected thereto, said system comprising a first device with a first transmitter and a first receiver and a second device with a second transmitter and a second receiver, which first and second devices interact to carry out the method as claimed in claim 1.

9. The system as claimed in claim 8, wherein the first device is associated with the vehicle chassis and is connected to an electrical network of the vehicle.

10. The system as claimed in claim 8, wherein the second device comprises a dedicated electrical power supply that is independent of an electrical power supply of the first device or of a power supply of the vehicle.

11. The system as claimed in claim 8, wherein an electrical power supply for one of the two devices is a lithium-ion battery.

12. The system as claimed in claim 8, wherein an electrical power supply for one of the two devices has a capacity of less than or equal to 10 Ah.

13. The system as claimed in claim 8, wherein an electrical power supply for one of the two devices has an output voltage of about 5.4 V or less.

14. The system as claimed in claim 8, wherein the two devices are attached to the vehicle outside of the pneumatic suspension bellows.

15. An electronically controlled pneumatic suspension for a vehicle, with a system as claimed in claim 8.

16. The pneumatic suspension as claimed in claim 15, comprising a manually actuated valve arrangement for raising and/or lowering a vehicle body/vehicle chassis.

17. The pneumatic suspension as claimed in claim 15, comprising a pneumatic suspension valve.

18. The pneumatic suspension as claimed in claim 15, comprising a pressure sensor for the measurement of the pressure prevailing within a pneumatic suspension bellows.

19. A vehicle with a pneumatic suspension as claimed in claim 15.

20. An electronic control unit for an electronically controlled pneumatic suspension as claimed in claim 15, comprising an interface for receiving the signal forwarded or further processed by the first device and with software for processing the signal.
